(19) United States
(12) Patent Application Publication
(10) Pub. No.: US 2017/0209322 A1
(43) Pub. Date: Jul. 27, 2017

(54) ELECTRIC ACTUATOR SYSTEM

(71) Applicant: LINAK A/S, Nordborg (DK)

(72) Inventor: Jørgensen Preben, Sønderborg (DK)

(73) Assignee: LINAK A/S, Nordborg (DK)

(21) Appl. No.: 15/326,573

(22) PCT Filed: Jul. 17, 2015
(86) PCT No.: PCT/DK2015/000028

§ 371 Date: Jan. 16, 2017

(30) Foreign Application Priority Data
Jul. 17, 2014 (DK) PA 2014 00400

(51) Int. Cl. A61G 7/018; H01R 27/02; H01R 13/717; H01R 24/64; F21V 23/06; F21V 33/00

(52) U.S. Cl. CPC A61G 7/018; F21V 23/06; F21V 33/0012; H01R 13/717; H01R 24/64; H01R 27/02; F21Y 2115/10

(57) ABSTRACT

Electric actuator system preferably for furniture, especially beds such as hospital, care or domestic beds comprising at least one actuator (6, 7; 21) for bringing about the adjustment of the article of furniture, a mains-based power supply (26, 31) and typically also a rechargeable battery pack, a controller (25;32), at least one operating unit (14, 29) and an orientation light (16). The actuator system is equipped with at least one socket (15) for a plug, and the orientation light (16) is designed as a separate unit with a plug (17) for cooperation with the socket (15) or one of the sockets in the actuator system. Hereby, a simplification of the structure of the actuator system and great flexibility with regard to equipping the actuator system with an orientation light (16) is achieved. Further, it becomes simple to replace the orientation light (16) in case it breaks or a different light intensity or color is desired.

The invention relates to an electric actuator system, preferably for furniture such as hospital, care or domestic beds comprising at least one actuator for bringing about the adjustment of one or more adjustable parts of the article of furniture, a mains-based power supply and typically also a rechargeable battery pack, a controller, at least one operating unit and an orientation light.

A special design or use of orientation light for beds is underbed light. Here, the orientation light is placed under the bed and emits light towards the floor. In connection with hospital and care beds underbed light is used by the occupants of the bed and the staff for finding their way when the room, in which the bed or the beds is/are located, is dark. Some also uses it as a sort of watch light. Orientation light in the shape of an underbed light has as such been known for many years, cf. e.g. U.S. Pat. No. 2,185,051, Daigle, published 26 Dec. 1939. The document discloses a non-adjustable double bed, where the slatted frame rests on spring-loaded switches, which control a central light source under the bed. It is therefore necessary to supply the bed with power with the sole purpose of supplying the orientation light.

The situation concerning electric adjustable beds is quite different as power is already being supplied to the bed. As an example of such an electrically adjustable bed with orientation light reference is made to U.S. Pat. No. 6,234,642 B1, Dewert Antriebs- and Systemtechnik GmbH & Co. KG. The document relates to a hospital or care bed, where a back rest and leg section of a slatted frame can be adjusted by means of electric drives. Here, the electric drives each have a control box with built-in orientation light. The orientation light comprises a light emitting diode secured to a printed circuit board. The light is led out through the control box by means of an optical rod or a lens. WO 00/33785 A1 to Huntleigh Technology Inc., which concerns a hospital bed, mentions in broad terms placement of orientation light in a central housing under the bed, said housing contains all the actuators used for adjusting the bed. U.S. Pat. No. 7,874,695 B2, to Linak A/S discloses an adjustable hospital bed, where the orientation light is placed in an electric junction box which with a cable is connected to the control box. Thus, a more flexible placement of the orientation light compared to the previously mentioned constructions is achieved. On the other hand there is the problem of having to run cables on the bed. The cabling should be handled with circumspection such that the cables are not damaged by the adjustable parts of the bed.

As examples of other constructions of orientation light for beds reference is made to JP-U-5-93305, where numerous light sources are located several places on the bed. Another example is JP-A-8-38311, where a light source is placed in each corner of the bed.

As it appears from the above the existing orientation lights do not only fundamentally alter the construction of the actuator system, but also to a greater or lesser extent the construction of the piece of furniture.

Further, several of the types of orientation light deals with problems concerning the cabling on or in the piece of furniture.

The purpose of the invention is to provide an actuator system where one or more of the outlined problems relating to orientation lights are avoided.

The actuator system according to the invention is characteristic in that it is equipped with at least one socket for a plug and that the orientation light is designed as a separate unit with a plug for cooperation with the socket in the actuator system. The entire construction of the actuator system is simplified in that the orientation light is designed as a separate unit with an integrated plug such that the unit can be inserted into a socket in the actuator system. Furthermore, the construction is wireless, thus further avoiding the problems relating to cabling. Further, it makes it possible to equip an actuator system with optional orientation light, thus simplifying the logistics. In case it should be desired to subsequently equip an actuator system with orientation light, this can be easily retrofitted. It further becomes easy to replace the orientation light in case it breaks or a different light intensity or color is desired. An actuator system can comprise one or more linear actuators in the shape of single actuators connected to just one control box containing a controller and a mains based power supply and possibly also a rechargeable battery pack, such that the piece of furniture can be adjusted, even though it temporarily is not connected to mains. An example of a linear actuator in the shape of a single actuator is known from WO2002/29284 A1 to Linak A/S, where the actuator has an axially moveable driving rod. Another example without driving rod is known from WO1996/12123 A1 to Koch (OKIN), which is typically used for adjusting reclining chairs. In some actuators a part of the controller can be integrated in these, while the rest of the controller is located in the control box. In some cases the control box can be separated into a box containing the mains-based power supply and a second box containing the controller. This is e.g. used in connection with actuator systems for ,reclining chairs.

Hand controls or fixed control panels or other types of equipment can directly be connected to the control box. The orientation light can be designed with its own controller independent of the controller of the actuator system but it is preferred that controlling takes place through this, which e.g. can be some sort of bus, such as LINBUS or a dedicated bus as described in WO2007/057014 A1 to Linak A/S. A special embodiment of an actuator system is dual actuators for adjustable beds, where there in a common housing is a linear actuator in each end of the housing and where the power supply and controller are also contained in the housing. In an embodiment for the invention the socket or sockets for the orientation light is/are located in the actuator. This is typically the case for dual actuators but it is understood that it can also apply to linear actuators (single actuators). In the actuator system based on linear actuators in the shape of single actuators the socket or the sockets for orientation light is/are expediently placed in the control box. It is however understood that the socket or the sockets for orientation light naturally can be placed in both a linear actuator as well as in the control box. This can be expedient in the event that more than one orientation light is desired.

The orientation light can e.g. constantly be turned on, which naturally entails continuous energy consumption, but when using light emitting diodes as light source this is at a minimum. Alternatively, it can be turned on or switched off by means of a separate switch through one of the operating units. Another possibility is a light sensitive switch, which automatically turns on the orientation light, when the level of light in the room falls below a certain intensity.

An embodiment for the actuator system according to the invention will be described more fully below under reference to the accompanying drawing, which shows:

FIG. 1, a schematic view of a hospital bed,

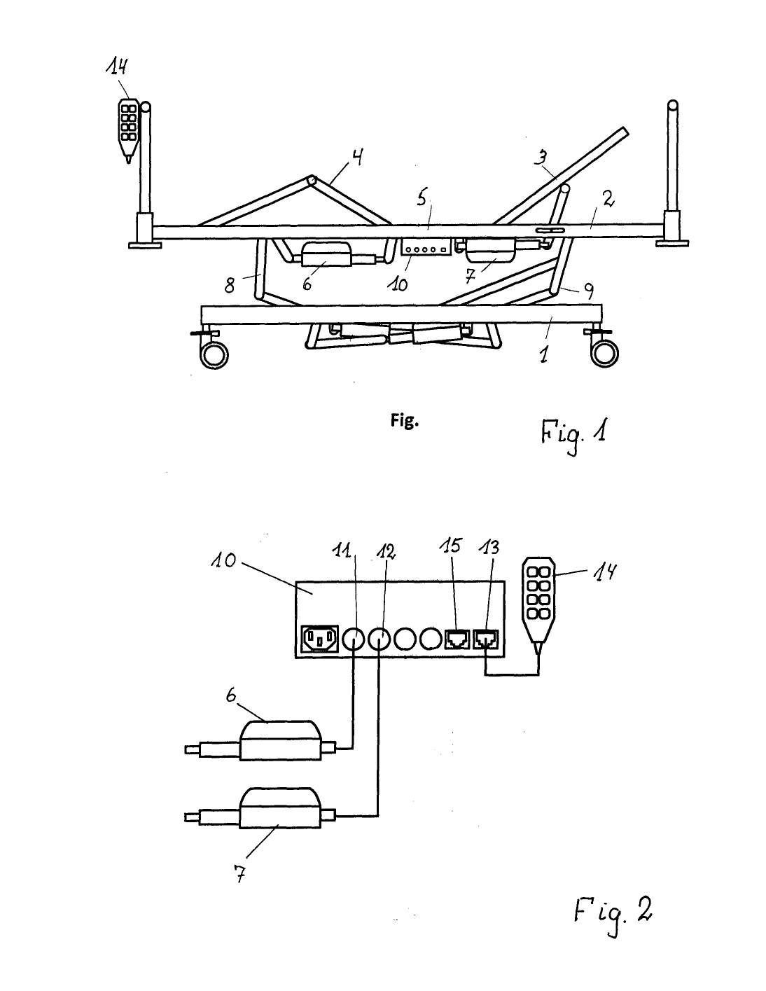

FIG. 2, a sketch of an actuator system with linear actuators in the shape of single actuators,

FIG. 3, a perspective view of the orientation light in the shape of an underbed light,

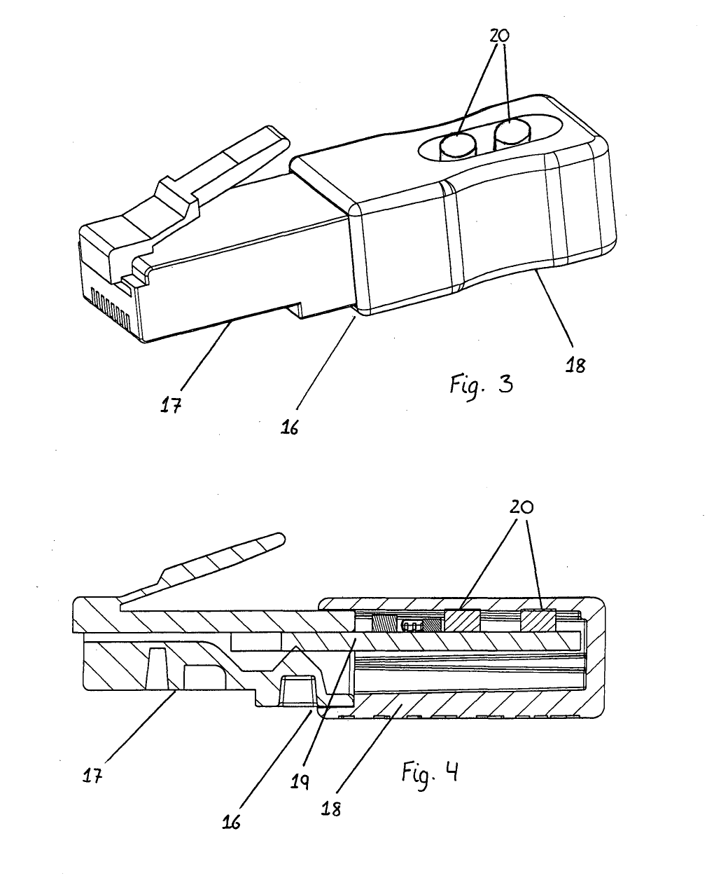

FIG. 4, a longitudinal section through the orientation light in FIG. 3,

FIG. 5, a perspective view of a control box for the actuator system shown in FIG. 2,

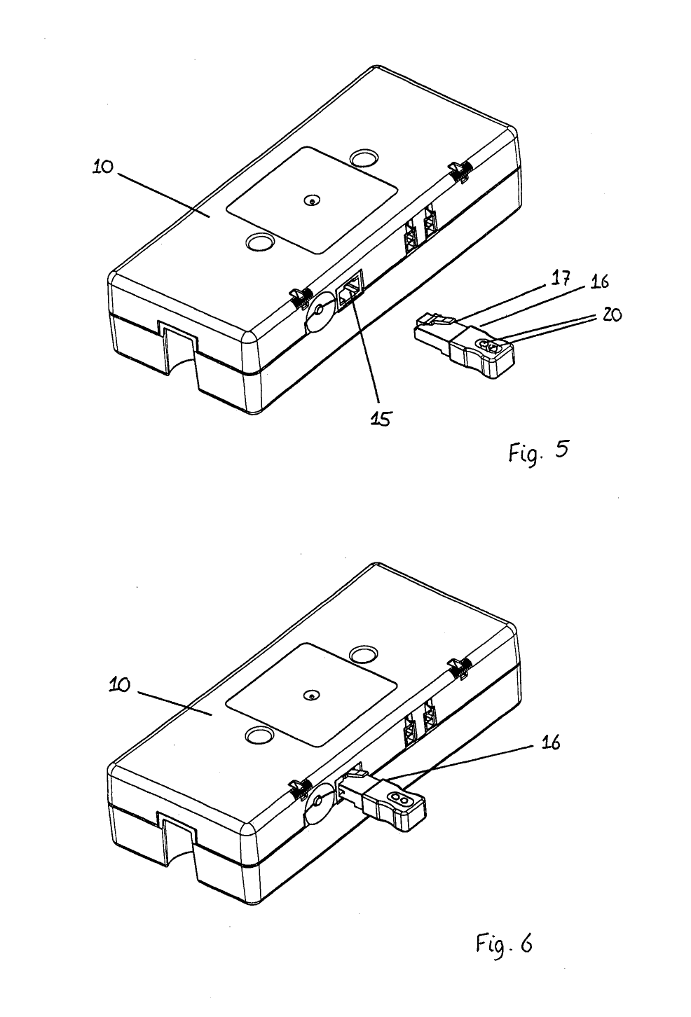

FIG. 6, a view of the control box where the orientation light is mounted in a socket,

FIG. 7, an actuator system in the shape of a dual actuator,

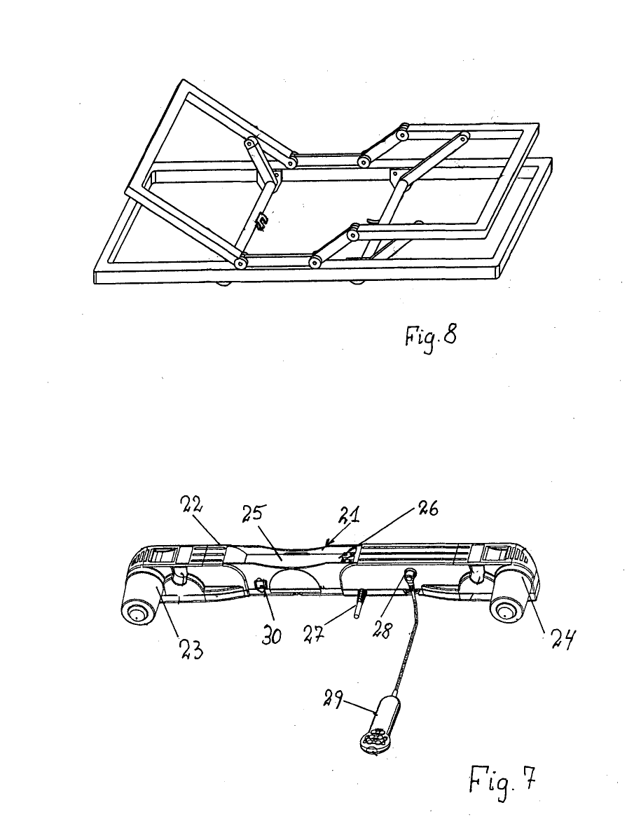

FIG. 8, a schematic view of an adjustable carrying surface for a mattress, where the adjustment is performed by means of a dual actuator as shown in FIG. 7,

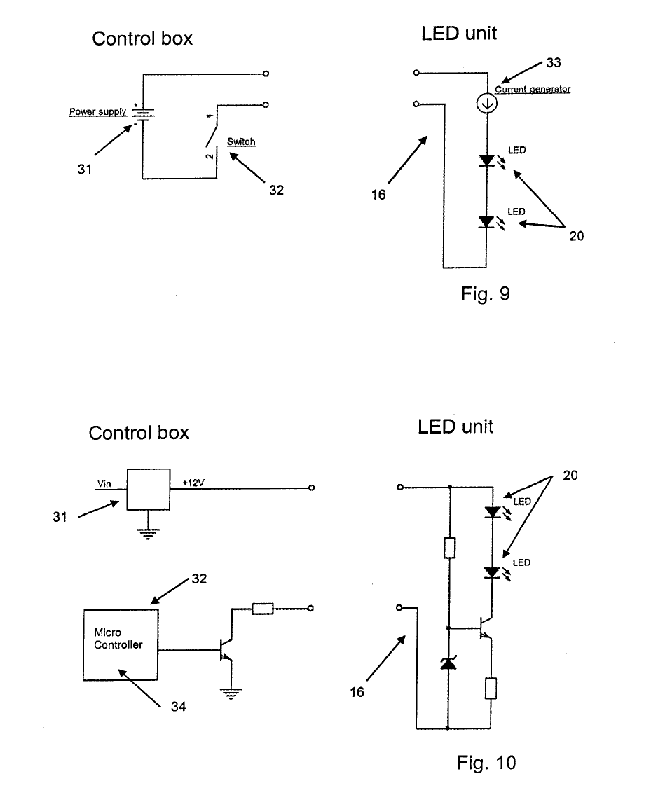

FIG. 9, a block diagram of a power supply, controller and orientation light, and

FIG. 10, an embodiment of the block diagram in FIG. 9.

The bed shown in FIG. 1 of the drawing comprises a lower frame 1 and an upper frame 2. The upper frame is furnished with an adjustable carrying surface for a mattress. The carrying surface comprises a backrest section 3, an articulated leg rest section 4 and a fixed middle section 5 between these. The back rest and leg rest section 3,4 can be adjusted by means of an actuator 6,7 each such that the carrying surface can assume various contours. The upper frame 2 is connected to the lower frame 1 with a link connection 8,9 at each end.

Under the bed, more precisely under the fixed middle section 5 of the carrying surface for the mattress, a control box 10 containing a controller and a power supply for connection to mains is mounted. The control box 10 has a number of sockets of which two sockets 11,12 are for connection of the actuators 6,7 to the control box and further there is a socket 13 for connection of a hand control 14 to the control box. In addition to this there is a further socket 15, in which an orientation light 16 in the shape of an underbed light ca be inserted, The orientation light 16 is designed as a separate unit with a housing, where there in one end of the housing is an integrated plug 17 for inserting into the socket 15 in the control box. In addition to the plug establishing the electrical connection to the controller, it also functions as a mechanical fixing of the orientation light 16 to the control box. Here, the plug is designed as a Modular plug RJ45 8/8, but it is understood that it can also have other shapes such as Minifit, DIN or Jack. The housing 18 of the orientation light contains a printed circuit board 19 connected to the terminals in the plug 17. On the printed circuit board is mounted two light emitting diodes 20, which emit light towards the floor. FIG. 7 of the drawing shows a dual actuator 21 for adjustable beds. The dual actuator comprises a common housing 22 with a linear actuator 23,24 at each end. In the housing between the two actuators a controller 25 and a power supply 26 for connection to mains by means of a cable 27 is located. The dual actuator is equipped with a socket 28 for connecting a hand control 29, just as there is a socket 30 into which an orientation light unit 16 can be inserted.

For wireless remote-controlled actuator systems the socket which is otherwise used for a cable connected hand control can be used, such that it is unnecessary to provide an extra socket in the control box, alternatively in the common housing of dual actuators.

FIG. 9 of the drawing shows a block diagram of a power supply 31 and controller 32 for the orientation light 16 in the shape of a switch. In the orientation light 16 there is a printed circuit board 19 with a power generator 33 and two light emitting diodes LED 20. FIG. 10 shows a diagram of a possible embodiment with a power supply 31 and a controller 32 based on a microprocessor 34. A printed circuit board 19 in the orientation light 16 comprises the two LED lights 20 and is controlled by a transistor and a diode.

Though the invention is described above in connection with a bed it is understood that the invention can also be used in connection with other types of adjustable furniture, such as reclining chairs, desks, counters or raiseable/lowable cupboards, e.g. in the shape of kitchen wall cupboards.

1. Electric actuator system preferably for furniture, especially beds, such as hospital, care or domestic beds comprising at least one actuator for bringing about the adjustment of one or more adjustable parts of the article of furniture, a mains-based power supply and typically also a rechargeable battery pack, a controller, at least one operation unit and an orientation light with at least one light source, characterized in that the actuator system is equipped with at least one socket for a plug, and that the orientation light is designed as a separate unit comprising a housing designed with an integrated plug for cooperation with the socket in the actuator system and that the light source and corresponding electronics likewise are located in the housing.

2. Electric actuator system according to claim 1, wherein the plug is designed as a modular plug.

3. Electric actuator system according to claim 1, wherein the socket is located in an actuator.

4. Electric actuator system according to claim 1, wherein at least part of the controller is located in a control box.

5. Electric actuator system according to claim 4, wherein the socket is located in the control box.

6. Electric actuator system according to claim 1, wherein the mains-based power supply and typically also the rechargeable battery pack likewise are located in the control box.

7. Electric actuator system according to claim 1, wherein sockets are located in both the actuator as well as the control box.

8. Electric actuator system according to claim 1, wherein the orientation light comprises a printed circuit board with a power generator as power source for the light source, such as light emitting diodes.

9. Electric actuator system according to claim 1, wherein the controller comprises a microprocessor and that the orientation light comprises a controller for the light source in the shape of a transistor and a diode.
